(19) United States
(12) Patent Application Publication
(10) Pub. No.: US 2014/0175960 A1
(43) Pub. Date: Jun. 26, 2014

(54) VENDING MACHINE

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: YUN-LUNG CHEN, New Taipei (TW); CHUNG CHAI, New Taipei (TW); DA-LONG SUN, Wuhan (CN); YU-GUI CHEN, Wuhan (CN); NIAN-YUAN YANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/972,877

(22) Filed: Aug. 21, 2013

(30) Foreign Application Priority Data
Dec. 22, 2012 (CN) 2012105618995

(51) Int. Cl. G07D 1/02

(52) U.S. Cl. CPC G07D 1/02
USPC 312/211

(57) ABSTRACT

A vending machine includes a change cabinet, a guiding duct, and a guiding member. The change cabinet stores a plurality of coins. The change cabinet includes a bottom wall. The bottom wall defines an output opening. The guiding duct includes a bottom panel and two side panels extending from the bottom panel. The guiding member is mounted between the two side panels. The guiding member includes a guiding panel body. The change cabinet is mounted on the guiding duct to enable the output opening to be located between the two side panels. There is an acute angle defined between the guiding panel body and the bottom wall to guide a coin from the output opening to move to the bottom panel.

### BACKGROUND

1. Technical Field

The present disclosure relates to electronic devices, more particularly to a coin output for a vending machine.

2. Description of Related Art

Vending machines allow customers to buy product twenty fours a day, such as buying water, or tissues for example. When the customer retrieves the change from the vending machine, a shielding plate is pushed by the customer to expose an output opening to obtain the change, such as coins, from the output opening. However, there is a channel defined between a change cabinet and the shielding plate. It is possible to break the change cabinet to obtain change directly through the channel. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a vending machine in accordance with an embodiment.

FIG. 2 is an assembled view of the vending machine of FIG. 1.

FIG. 3 is a cross-sectional view of FIG. 2 taken along a line III-III.

FIG. 4 is an assembled view of FIG. 2, and the shielding plate of the vending machine being rotating inward.

FIG. 5 is a cross-sectional view of FIG. 4 taken along a line V-V.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

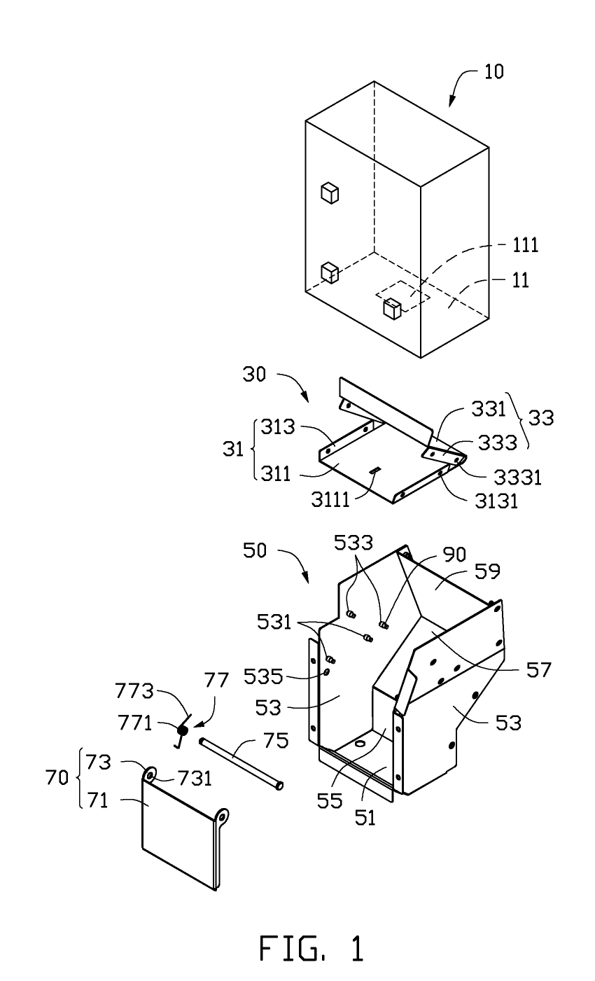

FIG. 1 illustrates a vending machine in accordance with an embodiment. The vending machine includes a change cabinet 10 mountable to an outer enclosure (not shown), a guiding member 30, a guiding duct 50, and a shielding plate 70 pivotally mounted to the guiding duct 50. The change cabinet 10 stores a plurality of coins.

The change cabinet 10 includes a bottom wall 11. The bottom wall defines output opening 111. The guiding member 30 includes a base panel 31, and a guiding panel 33 extending on a slant from the base panel 31. The guiding member 30 is V-shaped. The base panel 31 includes a base panel body 311 and two mounting flange 313, extending from the base panel body 311. The base panel body 311 defines a positioning opening 3111. Each mounting flange 313 defines two mounting holes 3131. The guiding panel 33 includes a guiding panel body 331 and two securing flanges 333, extending from the guiding panel body 331. The two securing flanges 333 are substantially perpendicular to the guiding panel body 331. There is a first acute angle a defined between the guiding panel body 331 and the base panel body 311. Each securing flange 333 defines two securing holes 3331.

The guiding duct 50 includes a bottom panel 51, two side panels 53 extending perpendicularly from the bottom panel 51, a connecting panel 55 extending perpendicularly from the bottom panel 51, an inclining panel 57 extending from the connecting panel 55, and an extending panel 59 extending from the inclining panel 57. The connecting panel 55, the inclining panel 57, and the extending panel 59 are connected between the two side panels 53. The bottom panel 51 is substantially parallel to the base panel 31. There is a second acute angle β defined between the inclining panel 57 and the bottom panel 51. Each side panel 53 defines two through holes 531 corresponding to the mounting holes 3131 and two locking holes 533 corresponding to the securing holes 3331. Each side panel 53 defines a pivot hole 535.

The shielding plate 70 includes a shielding plate body 71 and two pivot portions 73 extending from the shielding plate body 71. Each pivot portion 73 defines a rotating hole 731. The vending machine further includes a pivot shaft 75 and a torsion spring 77. The torsion spring 77 includes a spring body 771 and two elastic arm 773 extending from the spring body 771. The spring body 771 is used for surrounding the pivot shaft 75. The pivot shaft 75 corresponds to the rotating holes 731 and the pivot holes 535.

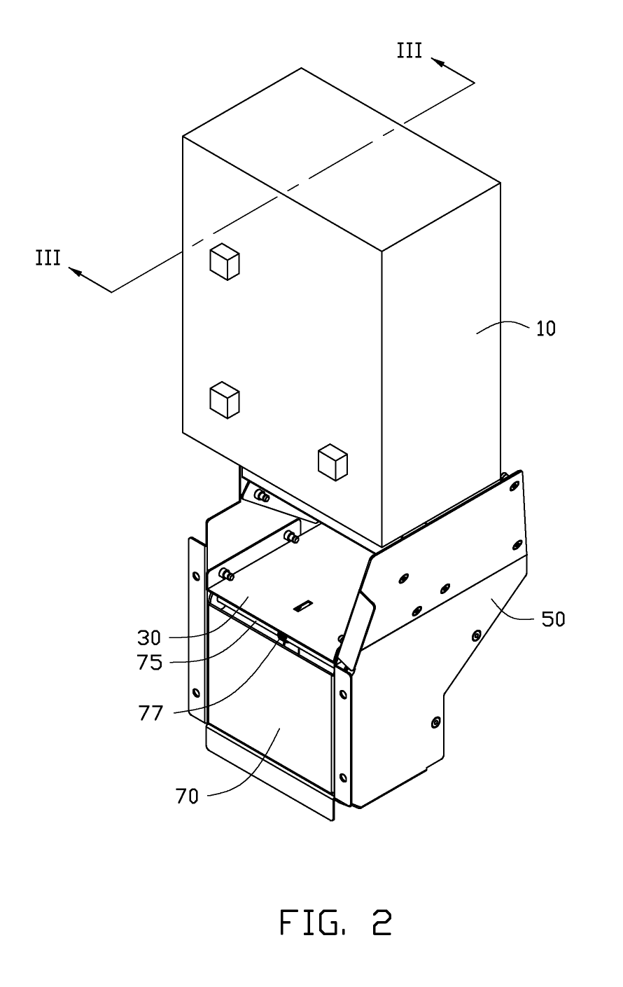

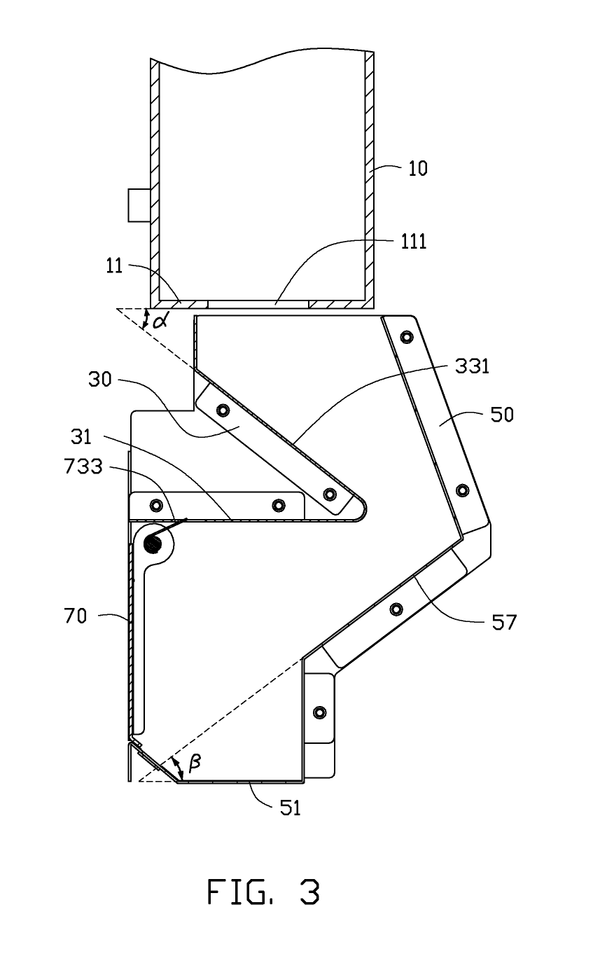

FIGS. 2 and 3 illustrate that in assembly, the pivot shaft 75 passes through one of the two pivot holes 535 and one of the two rotating holes 731. The spring body 771, of the torsion spring 77, surrounds the pivot shaft 75. The pivot shaft 75 passes through the other one of the two pivot holes 535 and the other one of the two rotating hole 731, to be pivotally mounted to the guiding duct 50. The guiding member 30 is placed between the two side panels 53 of the guiding duct 50 and is placed on the shielding plate 70. The mounting holes 3131 and the securing holes 3331 of the guiding member 30 are aligned with the through holes 531 and the locking holes 533. One of the two elastic arm 773 of the torsion spring 77 is placed in the positioning opening 3111 of the base panel body 311. At this time, the other one of the two elastic arms 773 resists the inner side of the shielding plate 70. A plurality of fasteners 90 are secured in the through holes 531 and the corresponding mounting holes 3131 and a plurality of fasteners 90 are secured in the locking holes 533 and the corresponding securing holes 3331, thereby securing the guiding member 30 to the guiding duct 50. The change cabinet 10 and the guiding duct 50 are mounted to the outer enclosure to enable the change cabinet 10 to be located above the guiding duct 50, and to enable the output opening 111 of the change cabinet 10 to be placed between the two side panels 53.

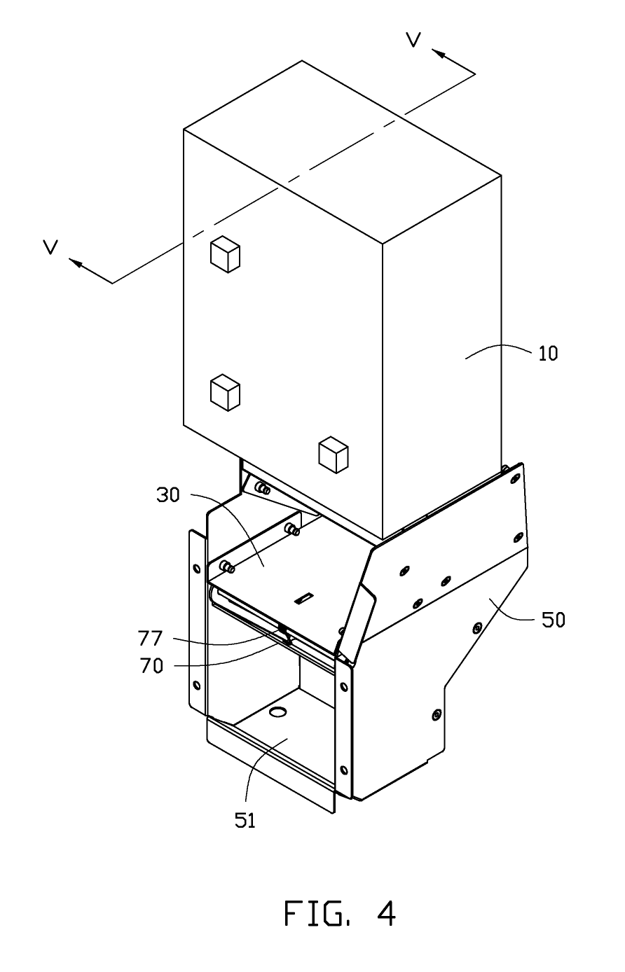

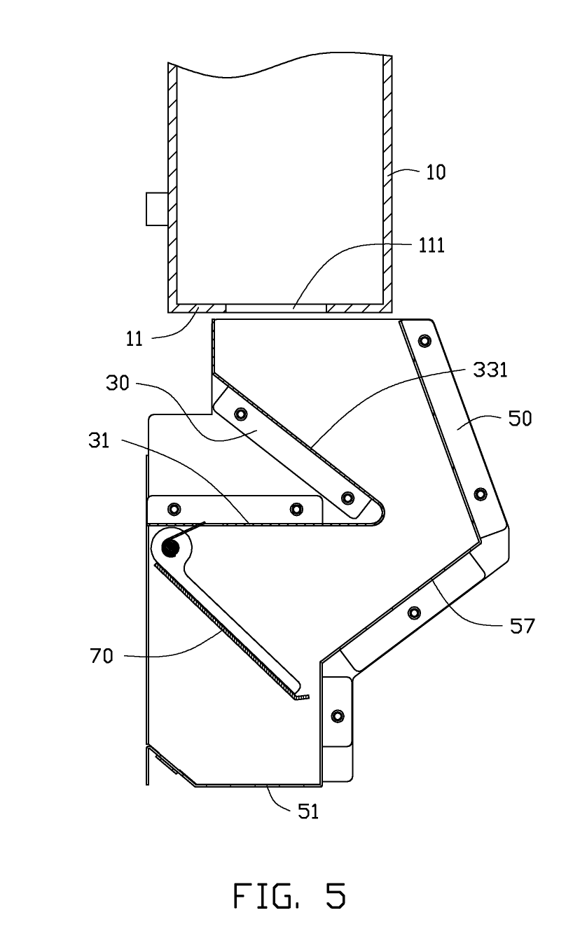

FIGS. 4 and 5 illustrate that in use, when the vending machine should give the change to the customer, the change cabinet 10 outputs coins from the output opening 111. The coins moves down along the guiding panel 33 and drops on the inclining panel 57. The inclining panel 57 guides the coins to move to the bottom panel 51 of the guiding duct 50. The shielding plate 70 is pushed to rotate by the customer to obtain the coins. The torsion spring 77 drive the shielding plate 70 to move back when the shielding plate 70 is applied without force. The shielding plate 70 is pushed and people cannot contact the output opening 111 because of the isolation of the guiding member 30.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A vending machine comprising:
a change cabinet storing a plurality of coins, the change cabinet comprising a bottom wall, and the bottom wall defines an output opening for outputting coins;
a guiding duct, the guiding duct comprising a bottom panel and two side panels extending from the bottom panel; and
a guiding member, the guiding member is mounted between the two side panels; the guiding member comprises a guiding panel body located between the bottom wall and the bottom panel;
wherein the change cabinet is mounted on the guiding duct to enable the output opening to be located between the two side panels; and there is an acute angle defined between the guiding panel body and the bottom wall.

2. The vending machine of claim 1, wherein the guiding member further comprises a base panel extending from the guiding panel body; and the base panel is secured between the two side panels; and the guiding member is V-shaped.

3. The vending machine of claim 2, wherein the base panel comprises a base panel body and two mounting flanges extending from the base panel body; each of the two mounting flanges defines a mounting hole; and each of the two side panels defines a through hole corresponding to the mounting hole.

4. The vending machine of claim 3, wherein the base panel body is substantially parallel to the bottom panel.

5. The vending machine of claim 3, wherein the two mounting flanges are substantially perpendicular to the base panel body.

6. The vending machine of claim 3, wherein the base panel body is substantially parallel to the bottom wall.

7. The vending machine of claim 3, further comprising a shielding plate pivotally mounted between the two side panels, and the shielding plate is located between the base panel body and the bottom panel.

8. The vending machine of claim 7, further comprising a torsional spring; wherein the torsional spring comprises a spring body, a first elastic arm, a second elastic arm; the base panel body defines a positioning opening; the first elastic arm resists an inner side of the shielding plate; and the second elastic arm is received in the positioning opening.

9. The vending machine of claim 3, further comprising a torsional spring; wherein the torsional spring comprises a spring body, a first elastic arm, a second elastic arm; the base panel body defines a positioning opening; the guiding duct comprises an inclining panel;
there is an obtuse angle defined between the inclining panel and the bottom panel; and the inclining panel is located between the guiding panel body and the bottom panel.

10. The vending machine of claim 1, wherein the guiding member further comprises two securing flanges extending from the guiding panel body; each of the two securing flanges defines a securing hole; and each of the two side panels defines a locking hole corresponding to the securing hole.

11. A vending machine comprising:
a change cabinet storing a plurality of coins, the change cabinet comprising a bottom wall, and the bottom wall defines an output opening for outputting coins;
a guiding duct, the guiding duct comprising a bottom panel and two side panels extending from the bottom panel;
a guiding member, the guiding member is mounted between the two side panels; the guiding member comprises a guiding panel body located between the bottom wall and the bottom panel; and there is an acute angle defined between the guiding panel body and the bottom wall; and
a shielding plate pivotally mounted between the two side panels; the shielding plate is in a first position when the shielding plate in a free state; the shielding plate is substantially perpendicular to the bottom wall in the first position; the shielding plate is configured to be pushed by a customer to rotate from the first position to a second position.

12. The vending machine of claim 11, wherein the guiding member further comprises a base panel extending from the guiding panel body; the base panel is secured between the two side panels; and the guiding member is V-shaped.

13. The vending machine of claim 12, wherein the base panel comprises a base panel body and two mounting flanges extending from the base panel body; each of the two mounting flanges defines a mounting hole; and each of the two side panels defines a through hole corresponding to the mounting hole.

14. The vending machine of claim 13, wherein the base panel body is substantially parallel to the bottom panel.

15. The vending machine of claim 13, wherein the two mounting flanges are substantially perpendicular to the base panel body.

16. The vending machine of claim 13, wherein the base panel body is substantially parallel to the bottom wall.

17. The vending machine of claim 13, further comprising a shielding plate pivotally mounted between the two side panels, and the shielding plate is located between the base panel body and the bottom panel.

18. The vending machine of claim 17, further comprising a torsional spring; wherein the torsional spring comprises a spring body, a first elastic arm, a second elastic arm; the base panel body defines a positioning opening; the first elastic arm resists an inner side of the shielding plate; and the second elastic arm is received in the positioning opening.

19. The vending machine of claim 13, further comprising a torsional spring; wherein the torsional spring comprises a spring body, a first elastic arm, a second elastic arm; the base panel body defines a positioning opening; the guiding duct comprises an inclining panel;
there is an obtuse angle defined between the inclining panel and the bottom panel; and the inclining panel is located between the guiding panel body and the bottom panel.

20. The vending machine of claim 11, wherein the guiding member further comprises two securing flanges extending from the guiding panel body; each of the two securing flanges defines a securing hole; and each of the two side panels defines a locking hole corresponding to the securing hole.
